(19) United States
(12) Patent Application Publication
(10) Pub. No.: US 2006/0061294 A1
(43) Pub. Date: Mar. 23, 2006

(54) LED wiring method without the use of a rectifier

(76) Inventor: Christopher David Bawden, Emmett, KS (US)

Correspondence Address: Christopher David Bawden, 15354 A4 Road, Emmett, KS, 66422-9625, US

(21) Appl. No.: 10/947,565

(22) Filed: Sep. 22, 2004

(51) Int. Cl. H05B 41/14

(52) U.S. Cl. 315/200 R

(57) ABSTRACT

My invention is a wiring method for Light Emitting Diodes (LEDs) to be able to operate on alternating current without the use of a rectifier. This invention will allow the production and manufacture of LED bulbs of significant lumen output to be less expensive than it is now. This invention will allow lighting applications in all forms to become extremely more efficient then they are now.

### BACKGROUND OF THE INVENTION

The field of endeavor to which this invention pertains is: Any and all electric illumination devices. Including, but not limited to, alternating current voltage, direct current voltage, voltage ranges of 0.001 to 12470, retrofit applications, and new applications. For: Residential, commercial, industrial, institutional, alternative energy, signaling, identifing, control, safety, recreational, decoration, and security illumination devices and their related components.

### BRIEF SUMMARY OF THE INVENTION

The general idea of this invention is to allow the illumination of Light Emitting Diodes (LEDs) without the use of a rectifier. Therefore, allowing cost of manufacture of LED “lightbulbs” of significant lumen output to be less expensive. LED illumination allows for low power consumption and low heat emissions. Therefore, by increasing light output, lowering power consumed allows for less pollution caused by the generation of power needed to power the light. The object of this invention is to allow for LED lighting to be put into use in all aspects of conventional and non-conventional lighting in use today.

This invention is a LED wiring method that can be used in countless lightbulb manufacturing processes and applications. This invention allows for Light Emitting Diodes (LEDs) to be wired together without the use of a rectifier. LEDs are designed to operate on direct current. To operate LEDs on alternating current a rectifier is used to change the AC to DC. This invention has eliminated the need for a rectifier allowing the cost of producing LED illumination devices that run on AC current to be significantly reduced.

1. I, Christopher Bawden claim that my invention of a wiring method for light emitting diodes (LEDs) on alternating current without the use of a rectifier functions properly and allows for a steady illumination.
